(19) United States
(12) Patent Application Publication
(10) Pub. No.: US 2017/0143568 A1
(43) Pub. Date: May 25, 2017

(54) STRUCTURAL ARRANGEMENT FOR A HOSPITAL BED PROVIDED WITH A PHYSIOLOGICAL DECUBITUS SYSTEM

(71) Applicant: Eduardo Antônio CAUDURO, Cachoeira do sul (BR)

(72) Inventors: Eduardo Antônio CAUDURO, Cachoeira do sul (BR); Luis Antônio Silva TAVARES, Cachoeira do Itapemirim (BR)

(21) Appl. No.: 15/126,169

(22) PCT Filed: Jun. 9, 2014
(86) PCT No.: PCT/BR2014/000189

§ 371 Date: Sep. 14, 2016

(30) Foreign Application Priority Data
Mar. 14, 2014 (BR) BR2020140061210

(51) Int. Cl. A61G 7/057; A61G 7/08; A61G 7/018; A61G 7/05; A61G 7/015; A61G 7/012

(52) U.S. Cl. CPC A61G 7/0573; A61G 7/015; A61G 7/012; A61G 7/018; A61G 7/0514; A61G 7/08; A61G 2203/12

(57) ABSTRACT

It is described a constructive arrangement in hospital bed provided with physiological decubitus system comprising a fixed base (10), a moving base (20), a fixed pallet (30) and a moving pallet (40), describing an electric-mechanical actuator (50), driven by a timer, responsible for the up and down movement of the moving pallet (40) and two electric-mechanical actuators (60 and 61) responsible for the bed elevation movements (seat, back and knees) driven manually through the remote control and connected to the command center. Electric-mechanical actuators (50) and (60 and 61) allow the bed elevation and support point switching of the patient over the bed, promoting a silent and imperceptible work.

The present utility model refers to a constructive arrangement in hospital bed provided with physiological decubitus system. More specifically, it comprises a set of platforms formed by quadrangular segments keeping parallel in the longitudinal direction, having a fixed pallet and a moving pallet, fixed to a moving base and driven by a system of electric-mechanical actuator controlled by a timer, allowing the support point switching of the patient over the bed and promoting a silent and imperceptible work.

Pressure ulcers, previously known as decubitus eschar, correspond to a particular type of varying skin lesions, extension and depth, which can compromise the deeper tissues. The main cause of the formation of pressure ulcers is prolonged deficiency in blood irrigation and the supply of nutrients and oxygen in a certain area of the body, due to the pressure exerted by bony or cartilaginous prominence against a hard object causing the collapse of the vessels blood. The moisture and friction are conditions that help to aggravate the situation.

Sores can appear in several body support areas, especially behind the head, the back, the articulation of shoulder, elbow and hip, in the sacrococcygeal region, buttocks and heels. People in wheelchairs are more likely to develop bedsores in the region of ischia, bones of the pelvic girdle that supports the body in the sitting position. Chronic venous insufficiency can cause ulceration on the legs called venous stasis ulcer. Condition that differs from the pressure ulcer both in the diagnosis and in the therapy.

People who are most at risk of developing pressure ulcers: elderly, bedridden or immobilized for a long time, malnourished, patients with diabetes, fecal and/or urinary incontinence, those with an impaired level of consciousness or loss of tactile and/or thermal sensitivity and wheelchair users.

Several diseases can be associated with ulcerative skin lesions. The biopsy and culture examination are important features to establish the differential diagnosis in cases where the cause of the ulcerate lesion is not sufficiently clarified.

The main measure to prevent the formation of pressure ulcers is to change the position of bedridden patients every two hours at least, in order to relieve the points of the skin pressure in the areas of greatest risk.

In this sense, the state of the art presents the document EP0656183 describing a bed comprising a platform to support a person, a base supported on the floor to support the platform and means to hydraulically move at least a portion of the said platform related to the base, composed by a hydraulic cylinder, a hydraulic fluid, a directional valve to control the cylinder, a reservoir to hold the fluid and a regulating valve.

This document seeks to solve the problem of pressure ulcer formation in bedridden patients by moving a moving base before a fixed base, relieving the skin pressure points. However, this system has a hydraulic assembly composed of several components that end up generating large noise at the time of its drive and requiring constant maintenance due to its hydraulic assembly, making the movement of the bed noticeable and inconvenient to the bedridden patient occurring interruptions in the bed function with consequent loss in its effectiveness.

On the other hand, the state of the art describes the document BR MU8300015-1, of the same holder, comprising a hospital bed with the property to mobilize the patient in the bed, provided with pallet composed of independent metal profiles interleaved between fixed and moving, comprising four pistons connected to a hydraulic pump and padded metal profiles one by one by nylon foam and covered plastic material.

This document also seeks to solve the problem of pressure ulcer formation in bedridden patients by moving a moving base before a fixed base. However, this equipment has its drive through a hydraulic system that needs constant maintenance, generating great noise and discomfort to the bedridden patient. It also describes metal padded profiles one by one to allow the movement of the moving base and fixed base, making it a very uncomfortable bed to bedridden patient.

In this way, it is necessary an equipment provided with a set of platforms formed by quadrangular segments keeping parallel in the longitudinal direction, having a fixed pallet and a moving pallet fixed through a supporting structure provided with spaces allowing the organized movement and unable the moving pallet to get out the stroke. Being the fixed pallet attached to the fixed base and moving pallet attached to the moving base, the said moving base driven by an electric-mechanical actuator system controlled by a timer.

In order to describe the technical characteristics of the constructive arrangement in hospital bed provided with physiological decubitus system, the following figures are presented:

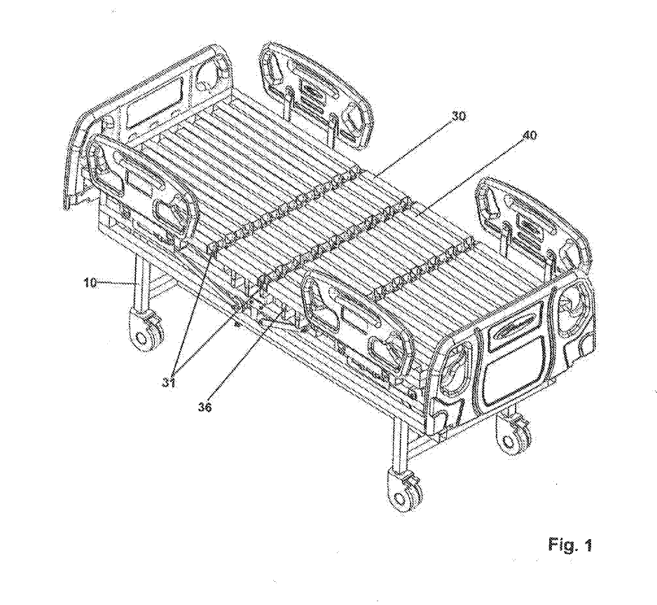

FIG. 1 illustrates the perspective view of the hospital bed.

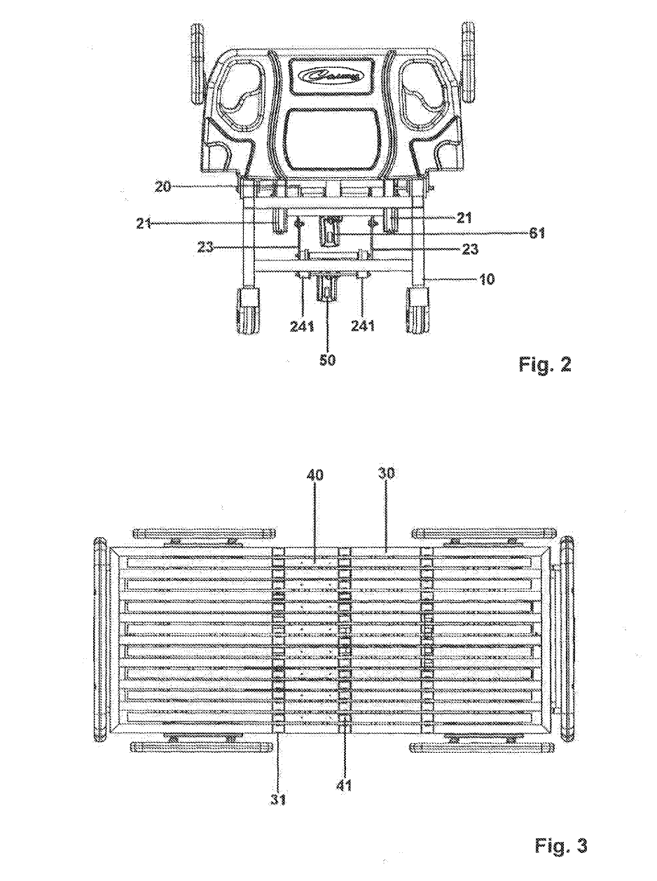

FIG. 2 illustrates the front view of the hospital bed.

FIG. 3 illustrates the upper view of the hospital bed.

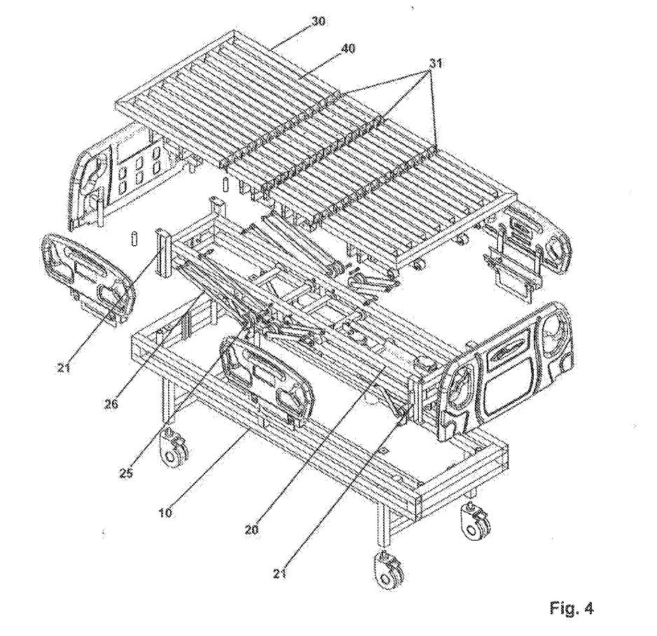

FIG. 4 illustrates the exploded perspective view of the hospital bed.

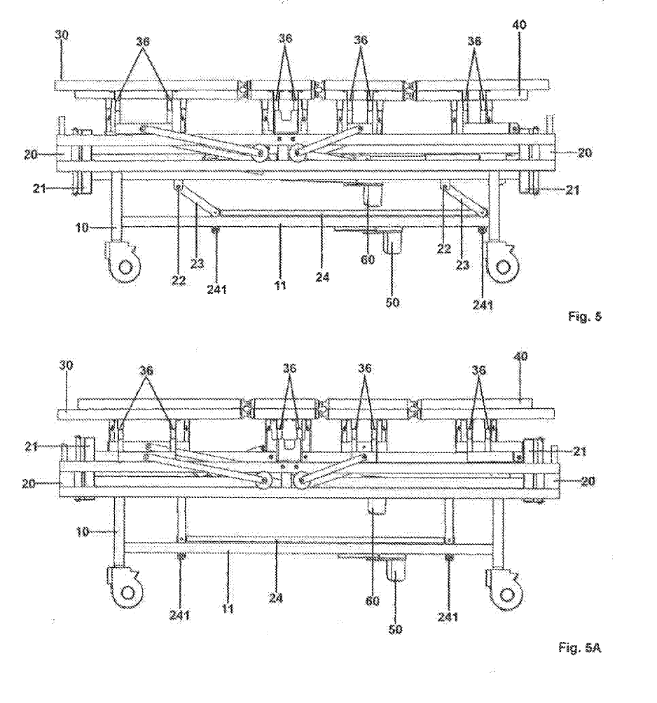

FIG. 5 illustrates the side view of the hospital bed with the system totally recovered and FIG. 5A illustrates the side view of the system totally elevated.

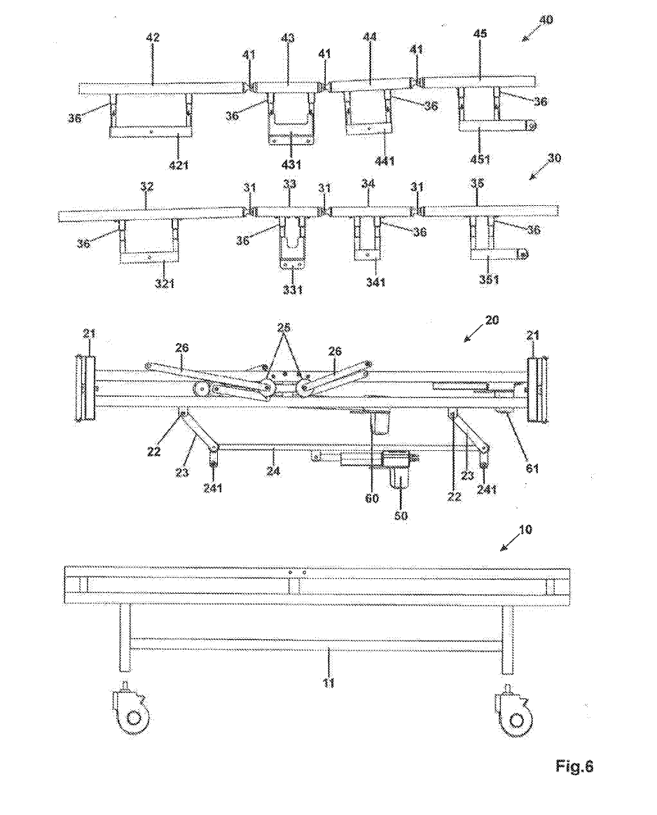

FIG. 6 illustrates the exploded side view of the hospital bed.

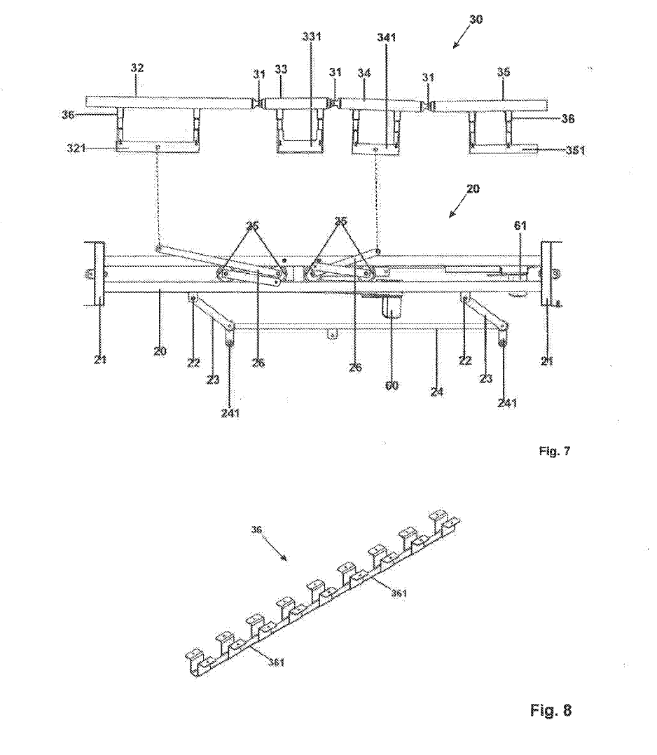

FIG. 7 illustrates the detailed view of the moving base and the pallets fixation.

FIG. 8 illustrates in details the supporting structure attached to the fixed pallet and provided with spaces supporting the moving pallet.

The hospital bed provided with physiological decubitus system, object of the present utility model, comprises a fixed base (10), a moving base (20), a fixed pallet (30) and a moving pallet (40), describing an electric-mechanical actuator (50) responsible for up and down movement of the moving pallet (40) and two electric-mechanical actuators (60 and 61) responsible for bed elevation movements (seat, back and knees), besides illustrating the headboards and safety handrails to the bedridden patient.

The said electric-mechanical actuator (60) drives the segments (32 and 42) of the bed representing the headboard. The said electric-mechanical actuator (61) drives the segments (34 and 44) representing the footboard. Both are manually driven through the remote control connected to the central command of the equipment.

The fixed base (10) has a rectangular structure provided with four supporting points having in their ends movement wheels and a longitudinal structure (11) for supporting the electric-mechanical actuator (50), the said structure (11) aims to guide the movement and the elevation of the moving base (20).

The moving base (20) described a rectangular structure provided with four pistons (21) described in the ends of the moving base (20) and attached to the fixed base (10), stabilizing the up and down movement of the moving pallet (40) and allowing the movement to become imperceptible to the bedridden patient.

In the lower portion of the moving base (20) it is described four fastening points (22) receiving articulated arms (23), attached to a bar (24) provided with sheaves (241), arranged over the structure (11) and driven by the electric-mechanical actuator (50). The said bar (24) performs a horizontal movement for vertical driving of the moving pallet (40).

In the central portion of the moving base (20) is described a set of sheaves (25) and articulated arms (26) performing the horizontal movement over the moving base (20) due to electric-mechanical actuators (60 and 61) drive, the said articulated arms (26) are attached into the supporting points (421) and (441) of the moving pallet (40) and in the supporting points (321) and (341) of the fixed pallet (30), promoting the moving pallet (40) elevation and consequently, the fixed pallet (30) movement, allowing the bed elevation (seat, back and knees), as the patient need. With that, the bed performs the patient movement in synchrony with the moving pallet (40) movement.

The fixed pallet (30) has a structure provided with quadrangular segments of 4 cm in each side and a space of 6 cm between its quadrangular segments, provided with three articulating points (31) promoting the division of the bed into four segments (32, 33, 34 and 35) allowing the bed elevation (seat, back and knees), as patient need. The said fixed pallet (30) has four segments (32, 33, 34 and 35) provided with connecting means (321, 331, 341 and 351) connected together with the moving base (20) and fixed base (10) through a set of sheaves (25) and bars (26), wherein the attachment (331) is attached directly into the fixed base (10) allowing the supporting and attachment of all fixed set (10).

The moving pallet (40) has a structure provided with quadrangular segments of 4 cm in each side and a space of 6 cm between its quadrangular segments, provided with three articulating points (41) promoting the division of the bed into four segments (42, 43, 44 and 45) allowing the bed elevation (seat, back and knees), as patient need. The said moving pallet (40) has four segments (42, 43, 44 and 45) provided with connecting means (421, 431, 441 and 451) together with the moving base (20) and fixed base (10) through a set of sheaves (25) and bars (26), wherein the attachment (431) is attached directly into the moving base (20) allowing the supporting and attachment of all moving set (20).

The fixed pallet (30) and the moving pallet (40) overlap between its spaces of 6 cm, forming a bed with interval of 1 cm between each element, keeping the pallets (30 and 40) parallel and in the longitudinal direction. So the connection of fixed pallet (30) and moving pallet (40) are performed by the set of sheaves and bars (25 and 26), have supporting structures (36) making it possible the moving pallet (40) to get out from the stroke in the elevation moment and fawler movement of the bed.

The connection structures (321, 341 and 351) of the fixed pallet (30) and connection structures (421, 441 and 451) of the moving pallet (40) are interconnected together with the moving base (20) through the set of sheaves and bars (25 and 26) allowing its movement. The attachment structure (331) is attached together with the fixed base (10) and the attachment structure (431) is attached together with the moving base (20) allowing supporting and attaching the fixed pallets (30) and moving pallet (40).

The fixed pallet (30) provided in its lower portion with supporting structure (36) receives in its spaces (361) the quadrangular segments overlapping resulted from moving pallet (40), allowing the organized movement of both pallets (30 and 40) and making it impossible the pallet (40) to get out from the stroke in the elevation moment and fawler movement. The said supporting structure (36) allows the bed elevation (seat, back and knees) in synchrony with the vertical movement of the moving pallet (40).

The movement (fawler) of the hospital bed provided with physiological decubitus system, occurs through electric-mechanical actuators (60 and 61) drive by a manual command through the remote control arranged together with the hospital bed, allowing the bedridden patient to perform the bed elevation (seat, back and knees) in synchrony with the vertical movement switching of the moving pallet (40). The said moving pallet (40) being moved through the electric-mechanical actuator (50) commanded by a timer.

The electric-mechanical actuator (50) when driven performs a horizontal movement offsetting a bar (24) over the longitudinal structure (11) promoting the vertical elevation of the moving base (20) and consequently, the vertical elevation of the moving pallet (40), switching between fixed pallet (30) and moving pallet (40) in the contact surface of the bed with the bedridden patient.

The vertical movement of the moving base (20) is provided by the electric-mechanical actuator (50), which when performing its horizontal movement promotes the moving base (20) and moving pallet (40) movement. The said moving base (20) is provided with four pistons (21) described in the moving base (20) ends and attached to the fixed base (10), stabilizing the up and down movement of the moving pallet (40) and allowing the movement to become imperceptible to the bedridden patient.

The hospital bed provided with decubitus system allows the electric-mechanical actuators (50) and (60 and 61) work together or individually, without interfering the movement of one of the other, allowing the system to work in synchrony.

The hospital bed provided with physiological decubitus system describes a system of vertical drive of the moving pallet (40) operating between the fixed pallet (30), controlled by a timer allowing setting the time and the switching interval between pallets, according to the need of the bedridden patient.

1. CONSTRUCTIVE ARRANGEMENT IN HOSPITAL BED PROVIDED WITH PHYSIOLOGICAL DECUBITUS SYSTEM, comprising a fixed base (10) provided with structure (11); a moving base (20) provided with four pistons (21), four fastening points (22) receiving articulated arms (23), a bar (24) provided with sheaves (241) and in the central portion a set of sheaves (25) and articulated arms (26); a fixed pallet (30) having a structure provided with quadrangular segments of 4 cm in each side and a space of 6 cm between its quadrangular segments, provided with three articulating points (31), four segments (32, 33, 34 and 35) of bed elevation, connecting means (321, 341 and 351) with the moving base (20) and fastening mean (331) with the fixed base (10), supporting structure (36) provided with spaces (361); a moving pallet (40) having a structure provided with quadrangular segments of 4 cm in each side and a space of 6 cm between its quadrangular segments, provided with three articulating points (41), four segments (42, 43, 44 and 45) of bed elevation and connecting means (421, 441 and 451) together with the moving base (20) and fastening mean (431) together with the moving base (20); an electric-mechanical actuator (50) for acting the moving pallet (40), managed by a timer, and two electric-mechanical actuators (60 and 61) for actuating the bed elevation, managed by the remote control.

2. CONSTRUCTIVE ARRANGEMENT IN HOSPITAL BED PROVIDED WITH PHYSIOLOGICAL DECUBITUS SYSTEM, according to claim 1, wherein the supporting structure (36) is fixed to the fixed pallet (30) and receives in its spaces (361) the quadrangular segments resulting from moving pallet (40).

3. CONSTRUCTIVE ARRANGEMENT IN HOSPITAL BED PROVIDED WITH PHYSIOLOGICAL DECUBITUS SYSTEM, according to claim 1, wherein it has four pistons (21) described in the moving base (20) ends.

4. CONSTRUCTIVE ARRANGEMENT IN HOSPITAL BED PROVIDED WITH PHYSIOLOGICAL DECUBITUS SYSTEM, according to claim 1, wherein the fixed pallet (30) and the moving pallet (40) overlap between its spaces of 6 cm, describing an interval of 1 cm between each element, keeping the platforms (30 and 40) parallel and in the longitudinal direction.
